(19) United States
(12) Patent Application Publication
(10) Pub. No.: US 2004/0160160 A1
(43) Pub. Date: Aug. 19, 2004

(54) Coil structure of deflection yoke in cathode ray tube

(76) Inventor: Gyoo Hwan Kim, Gurnis-si (KR)

Correspondence Address: MCKENNA LONG & ALDRIDGE LLP, 1900 K STREET, NW, WASHINGTON, DC, 20006, US

(21) Appl. No.: 10/724,398

(22) Filed: Dec. 1, 2003

(30) Foreign Application Priority Data
Nov. 30, 2002 (KR) 75652/2002

(51) Int. Cl. H01J 29/70

(52) U.S. Cl. 313/440

(57) ABSTRACT

A cathode ray tube mounted with: a front glass panel; a funnel connected to the panel, thereby forming a vacuum tube; an electron gun emitting electron beams; and a deflection yoke deflecting the electron beams emitted from the electron gun in the horizontal and vertical direction; wherein the deflection yoke comprises: a deflection coil wound of a coil wire deflecting the electron beams; wherein the coil wire has a core reinforcing a magnetic field generated around the deflection coil, and the deflection coil wire comprises an aluminum core; a copper layer surrounding the aluminum core; and an insulating layer surrounding the copper layer

This application claims the benefit of Korean Patent Application No. 75652/2002, filed on Nov. 30, 2002, which is hereby incorporated by reference for all purposes as if fully set forth herein.

### BACKGROUND OF THE INVENTION

1. Field of the Invention

The present invention relates to a coil structure of a deflection yoke in a cathode ray tube, and more particularly, to a coil structure of a deflection yoke in a cathode ray tube, capable of reducing the manufacturing cost and the weight of the cathode ray tube by applying a highly conductive aluminum layer having a cylindrical shape to the coil wires of the deflection yoke and by coating the aluminum layer with an insulating layer.

2. Description of the Related Art

FIG. 1 is a diagram explaining the structure of a color cathode ray tube of the related art. The color cathode ray tube has a panel 1 and a funnel 2 connected to the panel together forming a vacuum tube. Inside the panel 1 is a fluorescent screen 3 containing R, G, and B fluorescent substances (or phosphors), and an electron gun 4 for emitting red, green and blue electron beams 7 is housed in the neck portion of the funnel 2 on the opposite side of the fluorescent screen 3. A shadow mask 5 for selecting colors is disposed at a predetermined distance from the fluorescent screen 3 and the electron gun 4, more specifically, closer to the fluorescent screen 3. There is an inner shield 6 made of magnetic material to reduce the movement of electron beams due to external magnetic fields, particularly those from the rear side of the cathode ray tube. Also, a convergence purity magnet (CPM) 8 for adjusting the R, G, and B electron beams emitted from the electron gun 4 to converge on a point and a deflection yoke 9 for deflecting the electron beams 7 are mounted on a neck portion of the funnel 2. Also, a reinforcing band 10 is attached to an outside skirt portion of the panel to reinforce the front surface glass under the influence of high vacuum state of the inside (10⁻⁷ Torr-10⁻⁸ Torr). Because the high vacuum tube may be easily imploded by an external shock, it is necessary to design the panel strong enough to withstand atmospheric pressure. For instance, the reinforcing band 10 on the outside skirt portion of the panel 1 distributes tension in the high vacuum tube and thus, improves shock (or impact) resistance of the cathode ray tube.

To briefly explain the operation of the color cathode ray tube with the above structure, the electron beams 7 emitted from the electron gun 4 are deflected vertically and horizontally by the deflection yoke 9, and the deflected electron beams 7 pass through beam passing holes on the shadow mask 5 and strike the fluorescent screen 3 at the front, consequently displaying desired color images.

FIG. 2 illustrates a more detailed construction of the deflection yoke of the related art. The deflection yoke 9 consists of a horizontal deflection coil 21 for deflecting electron beams in the horizontal direction, and a vertical deflection coil 22 for deflecting electron beams in the vertical direction, a core 24 for minimizing a loss in a magnetic force generated by the horizontal and vertical deflection coils 21 and 22 on its return path, and a holder 23 for insulating between the horizontal and vertical deflection coils 21 and 22. Besides the main deflection coils like the horizontal and vertical deflection coils 21 and 22, there are auxiliary deflection coils for improving the deflection of the deflection yoke and performance of the cathode ray tube, and a board 27 mounted with a correction circuit for guiding the electron beams to arrive at a predetermined position on the screen. The auxiliary deflection coils include cancel coils 25a and 25b disposed on the top and bottom ends of the screen side of the holder 23, to cancel magnetic field leakage generated in the screen and neck portion of the deflection yoke 9, and fetch lines 26a and 26b.

In general, a horizontal deflection current having a frequency of 15.75 kHz or above flows in the horizontal deflection coil 21, and using the magnetic field generated around the coil, the deflection yoke deflects the electron beams 7 inside the cathode ray tube in the horizontal direction. In like manner, a vertical deflection current having a frequency of 60 Hz flows in the vertical deflection coil 22, and using the magnetic field generated around the coil, the deflection yoke deflects the electron beams 7 inside the cathode ray tube in the vertical direction. Therefore, an image is displayed on the screen as the deflection yoke 9 deflects the electron beams 7 in the horizontal and vertical directions and converges them to a point on the screen.

One type of currently used deflection yoke is a self-convergence type deflection yoke, which uses the non-uniform magnetic fields around the horizontal and vertical deflection coils 21, 22 in order to get the R, G, and B electron beams 7 to converge on the screen without using a separate additional circuit or device. By adjusting the turning distribution of the horizontal and vertical deflection coils 21 and 22, the self-convergence type deflection yoke creates a barrel or pin-cushion shaped magnetic field for each section (i.e., opening portion, middle portion, neck portion) and allows each of those three electron beams 7 to experience a different deflection force depending on their positions (yet to be converged upon one point despite different distances between the starting point to the arriving point on the screen), thereby hitting a corresponding fluorescent screen more accurately.

Here, the opening portion on the screen side indicates a portion adjacent to the screen having a relatively large diameter cross-section, and the opening portion on the neck side indicates a portion having a relatively small diameter cross-section on the opposite side of the screen side. The middle portion, as the name implies, indicates a middle portion of the opening portion on the screen side and the neck portion on the neck side.

One of typical problems cathode ray tube manufacturers are faced with is that it is actually very difficult to deflect the electron beams 7 onto the full screen if they use only the magnetic fields generated around the horizontal and vertical deflection coils 21 and 22 by flowing the horizontal and vertical deflection currents into the coils. Hence, the core 24 with a high magnetic permeability is usually employed to minimize the loss in the magnetic fields generated by the horizontal and vertical deflections coils 21 and 22 on its return path and to further improve magnetic efficiency and magnetic force.

FIG. 3 is a diagram explaining the shape of the horizontal deflection coil. The deflection coil is wound using coil wires. The horizontal deflection coil 21 has a saddle shape.

FIG. 4 is a diagram illustrating the structure of a coil wire used in the deflection yoke. The coil wire consists of a copper core 41, an insulating layer 42, and a bonding layer 43. Although it is not shown in the drawing, the vertical deflection coil 22 uses coil wire with the same structure with the above. More specifically, the insulating layer 42 coats the cylindrical copper core 41 having a 0.1 mm-0.4 mm diameter, and the bonding layer 43 surrounds outside the insulating layer 42. The copper has about 1.72×10⁻⁶ Ωcm (20° C.) of resistivity and 8.93 (20° C.) of specific gravity.

This kind of coil wire often has many problems. For example, copper which has a resistivity of 1.72×10⁻⁶ Ωcm (20° C.) has high electric conductivity. However, high frequency (15.75 kHz-110 kHz) alternating current applied to the horizontal deflection coil 21 generates eddy currents in the vertical deflection coil 22 because a magnetic field is generated around the coil. This results in a magnetic field generated in the vertical deflection coil 22 in a direction to cancel the magnetic field generated around the horizontal deflection coil 21. As such, a greater amount of current is required for the horizontal deflection coil 21, consequently generating more heat.

Another problem with the coils was that it is difficult to keep the coils in the best condition all the time because copper easily oxidizes when it is exposed to air.

### SUMMARY OF THE INVENTION

Accordingly, the present invention is directed to a coil structure of deflection yoke in a cathode ray tube that substantially obviates one or more of the problems due to limitations and disadvantages of the related art.

An advantage of the present invention is to provide a coil structure of deflection yoke in a cathode ray tube, capable of reducing the expense of manufacture and reducing weight of the cathode ray tube by applying a highly conductive aluminum layer having a cylindrical shape to coil of the deflection yoke and by coating the aluminum layer with an insulating layer.

Another advantage of the present invention is to provide a cathode ray tube mounted with: a front glass panel; a funnel connected to the panel, thereby forming a vacuum tube; an electron gun emitting electron beams; and a deflection yoke deflecting the electron beams emitted from the electron gun in the horizontal and vertical direction; wherein the deflection yoke comprises: a deflection coil wound of a coil wire deflecting the electron beams; wherein the coil wire has a core reinforcing a magnetic field generated around the deflection coil, and the deflection coil wire comprises an aluminum core; a copper layer surrounding the aluminum core; and an insulating layer surrounding the copper layer.

Another advantage of the invention provides a cathode ray tube mounted with: a front glass panel; a funnel connected to the panel, thereby forming a vacuum tube; an electron gun emitting electron beams; and a deflection yoke deflecting the electron beams emitted from the electron gun in the horizontal and vertical direction; wherein the deflection yoke comprises: a deflection coil wound of a coil wire deflecting the electron beams; a core reinforcing a magnetic field generated around the deflection coils, wherein the deflection coils comprises an aluminum core; and an insulating layer including an insulator at a predetermined thickness surrounding the aluminum core.

Another advantage of the invention provides a conductive coil wire, including: a conductive aluminum core; an insulating layer surrounding the conductive core; and a bonding layer including an adhesive surrounding the insulating layer.

Additional features and advantages of the invention will be set forth in part in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a diagram showing the construction of a color cathode ray tube of the related art;

FIG. 2 is a diagram illustrating detailed construction of a deflection yoke of the related art;

FIG. 3 is a diagram showing the shape of horizontal deflection coil of the related art;

FIG. 4 is a diagram illustrating a preferred structure of coil wire used in the deflection yoke of the related art;

FIG. 5 is a diagram showing a preferred structure of coil wire for the deflection yoke according to the present invention;

FIG. 6 is a diagram illustrating another embodiment of the coil wire structure for the deflection yoke according to the present invention;

FIG. 7 is a diagram illustrating yet another embodiment of the coil wire structure for the deflection yoke according to the present invention; and

FIG. 8 is a diagram illustrating still another embodiment of the coil wire structure for the deflection yoke according to the present invention.

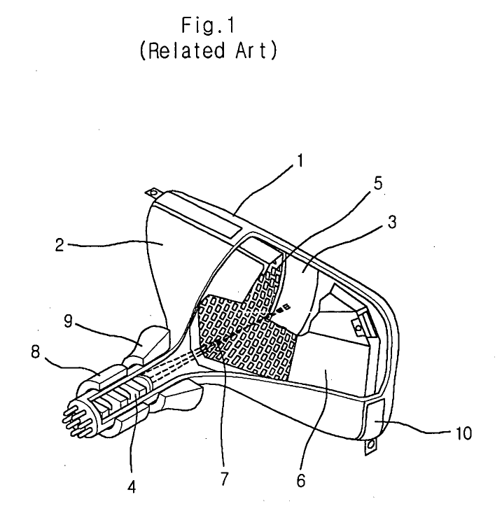

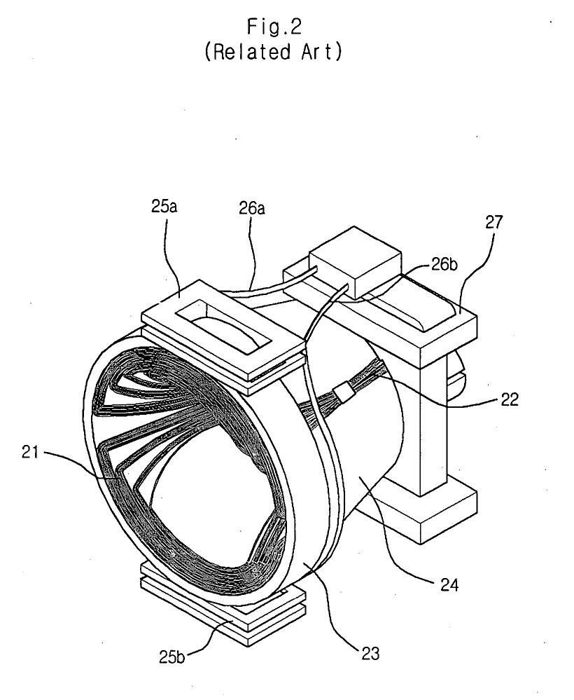

### DETAILED DESCRIPTION OF ILLUSTRATED EMBODIMENTS

Reference will now be made in detail to an embodiment of the present invention, example of which is illustrated in the accompanying drawings.

The deflection yoke in a cathode ray tube according to the present invention consists of a horizontal deflection coil for deflecting electron beams in the horizontal direction, and a vertical deflection coil for deflecting electron beams in the vertical direction, and a core for minimizing the loss in a magnetic force generated by the horizontal and vertical deflection coils on its return path. The deflection yoke may further include a holder for insulating between the horizontal and vertical deflection coils.

Auxiliary deflection coils for the deflection coil include canceling coils disposed on the top and bottom ends of the screen side of the holder to cancel magnetic field leakage generated in the screen and neck portion of the deflection yoke, fetch lines for connecting the canceling coils and the horizontal deflection coil, rotation coils, degaussing coils, CY coils, and CF coils. The auxiliary deflection coils do not have a direct influence on horizontal or vertical deflection, but have an importance influence on operational performance of the cathode ray tube and deflection efficiency.

To improve electrical efficiency and to reduce heat generation, the diameter of the horizontal deflection coil wire, vertical deflection coil wire, and auxiliary deflection coil wires is in the range from 0.1 mm to 0.7 mm. In the case of a monitor using a cathode ray tube, at least one of the horizontal deflection coil wire, vertical deflection coil wire, and auxiliary deflection coil wires should have a diameter of 0.1 mm to 0.4 mm. Also in the case of a TV using a cathode ray tube, at least one of the horizontal deflection coil wire, vertical deflection coil wire, and auxiliary deflection coil wires should have a diameter of 0.2 mm to 0.7 mm.

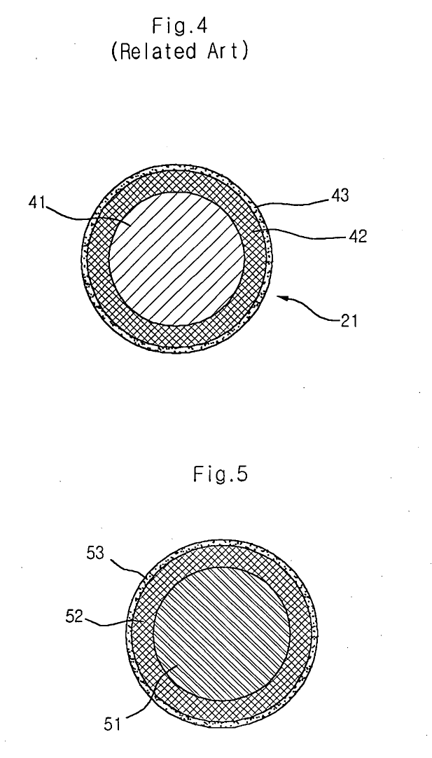

As shown in FIG. 5, a coil wire used in the horizontal and vertical deflection coils may be composed of a cylindrical aluminum core 51, an insulating layer 52 including an insulator at a predetermined thickness coating the circumference of the aluminum layer 51, and a bonding layer 53 including adhesives around the circumference of the insulating layer 52.

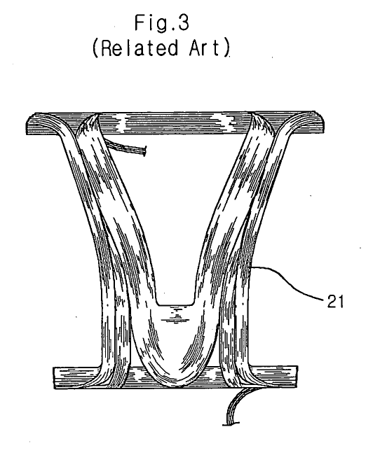

The deflection coil is either a saddle type or a toroidal type. For instance, when the saddle type deflection coil depicted in FIG. 3 is manufactured, the coil wire used in the horizontal or vertical deflection coil is preferably self-bonding wire, including the bonding layer 53 coated with adhesives for fusing wires on the outside the insulating layer 52.

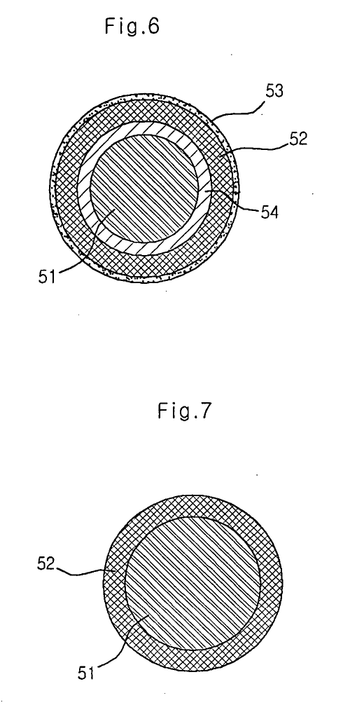

As illustrated in FIG. 5, the cylindrical aluminum core 51 is the inmost portion, and the next inmost portion is the insulating layer 52, and the bonding layer 53 is the outermost portion. Generally a high-frequency current usually tends to flow toward the outside of the wire (this phenomenon is called the ‘skin effect’). Thus, when aluminum is employed instead of copper, a greater amount of current should be applied to the coil because electrical resistance is higher in the aluminum. To solve this problem, the magnetic wire for use in the horizontal and vertical deflection coils, as illustrated in FIG. 6, includes a cylindrical aluminum core 51, a copper layer 54 outside the aluminum core 51, an insulating layer 52 outside the copper layer 54, and a bonding layer 53 outside the insulating layer 52.

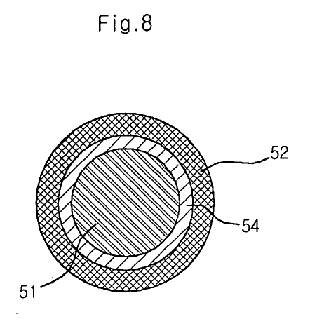

Meanwhile, FIG. 7 shows another example of the auxiliary deflection coil wire that includes only two layers, that is, the cylindrical aluminum core 51 as the inmost portion of the wire and the insulating layer 52 outside the aluminum core 51. Referring to FIG. 8, the auxiliary deflection coil wire may include three layers, that is, the cylindrical aluminum core 51 as the inmost portion of the wire, the copper layer 54 as the next inmost layer, and the insulating layer 52 as the outermost layer of the wire. In this case, windings of the auxiliary deflection coil core typically shorter than the windings of the deflection coils, so the difference between resistance and inductance for the auxiliary and deflection coils is not great. In other words, it is highly applicable to the present invention.

Employing aluminum wires instead of copper wires for use in the deflection coils has several advantages. First of all, aluminum does not easily react with oxygen as copper does, and its specific gravity of 2.6989 (20° C.) is almost one third the specific gravity of copper of 8.93 (20° C.). Hence, horizontal or vertical deflection coils using aluminum coil wires, weigh ⅓ the weight of horizontal or vertical deflection coils using copper coil wires. A lighter deflection yoke will no longer be pushed backward when it is mounted in the funnel. This lighter deflection yoke mounted in the funnel is not a heavy load on the brown tube at all, and thus, the brown tube becomes more stable.

The current flowing in the horizontal deflection coil of the deflection yoke has a frequency of 15.75 kHz-110 kHz. Because the current has a high frequency, the skin effect occurs, i.e., the current tends to flow far outside of the wire. Because aluminum has a higher resistance than copper, a greater amount of heat is generated by aluminum. To overcome this problem, as shown in FIG. 6, the aluminum core 51 is placed inside and the copper layer 54 having a lower resistance than the aluminum core 51 is placed where the skin effect occurs.

As aforementioned, the horizontal and vertical deflection coil wires may include only the copper layer 54 and insulating layer 52, where copper is the main ingredient. Also, the auxiliary deflection coil wires may include the aluminum core 51 and insulating layer 52, where aluminum is the main ingredient.

Additionally, the horizontal deflection coil wire may include the copper layer 54 and insulating layer 52, where copper is the main ingredient, and the vertical deflection coil wire, on the other hand, may include the aluminum core 51 and insulating layer 52, where aluminum is the main ingredient.

Therefore, a desirable structure of the conductive coil wire includes a conductive layer having aluminum as a main ingredient, an insulating layer with a predetermined thickness coating the conductive layer on the outside, and an outermost bonding layer to which adhesives are applied.

In addition, more effective conductive coil wire may be manufactured by including the copper dominant layer into the conductive layer.

The conductive coil may have a diameter of 0.1 mm-0.7 mm to improve its efficiency against electrical resistance and to reduce heat generation.

In conclusion, the present invention has the following advantages.

Aluminum coil wires are used instead of copper wires for the deflection coils because aluminum does not easily react with oxygen as copper does, and its specific gravity is 2.6989 (20° C.) that is almost one third of copper, 8.93 (20° C.). Hence, when manufacturers make horizontal or vertical deflection coils with the same size using aluminum wires, their weight would be 2/3 lighter than the horizontal or vertical deflection coils using copper wires. As the weight of the horizontal or vertical deflection coils is reduced, the deflection yoke is no longer pushed backward when it is mounted in the funnel. This lighter deflection yoke mounted in the funnel is not a heavy load on the cathode ray tube at all, and thus, the cathode ray tube becomes more stable. Also, aluminum is the most abundant metal found on the surface of the earth, and thus, its expense of manufacture is low. Also, because aluminum has a lower resistivity than copper, when aluminum coil wire is used particularly for the vertical deflection coil, it is possible to reduce current loss due to eddy current flowing in the vertical deflection coil under the influence of the horizontal deflection coil.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A cathode ray tube comprising:
a front glass panel;
a funnel connected to the panel, thereby forming a vacuum tube;
an electron gun emitting electron beams; and
a deflection yoke deflecting the electron beams emitted from the electron gun in the horizontal and vertical direction; wherein the deflection yoke comprises:
a deflection coil wound of a coil wire deflecting the electron beams;
wherein the coil wire has a core reinforcing a magnetic field generated around the deflection coil, and the deflection coil wire comprises:
an aluminum core;
a copper layer surrounding the aluminum core; and
an insulating layer surrounding the copper layer.

2. The cathode ray tube according to claim 1, wherein the deflection coil wire further comprises a bonding layer.

3. The cathode ray tube according to claim 1, wherein copper is a main ingredient of the deflection coil, and aluminum is a main ingredient of auxiliary deflection coils.

4. The cathode ray tube according to claim 1, wherein copper is a main ingredient of the horizontal deflection coil, and aluminum is a main ingredient of the vertical deflection coil.

5. The cathode ray tube according to claim 1, wherein the deflection yoke further comprises a holder for insulating the horizontal and vertical deflection coils.

6. A cathode ray tube comprising:
a front glass panel;
a funnel connected to the panel, thereby forming a vacuum tube;
an electron gun emitting electron beams; and a deflection yoke deflecting the electron beams emitted from the electron gun in the horizontal and vertical direction;
wherein the deflection yoke comprises:
a deflection coil wound of a coil wire deflecting the electron beams;
a core reinforcing a magnetic field generated around the deflection coils, wherein the deflection coils comprises:
an aluminum core; and
an insulating layer including an insulator at a predetermined thickness surrounding the aluminum core.

7. The cathode ray tube according to claim 6, wherein the deflection coil is a horizontal deflection coil or a vertical deflection coil.

8. The cathode ray tube according to claim 7, wherein the deflection coil is a saddle type.

9. The cathode ray tube according to claim 7, wherein the deflection coil is a toroidal type.

10. The cathode ray tube according to claim 6, wherein the deflection coil further comprises a bonding layer with adhesives being formed around the circumference of the insulating layer.

11. The cathode ray tube according to claim 10, wherein the deflection coil is a horizontal deflection coil or a vertical deflection coil.

12. The cathode ray tube according to claim 11, wherein the deflection coil is a saddle type.

13. The cathode ray tube according to claim 11, wherein the deflection coil is a toroidal type.

14. The cathode ray tube according to claim 6, wherein the deflection coil has a diameter ranging from 0.1 mm to 0.7 mm.

15. The cathode ray tube according to claim 14, wherein the deflection coil has a diameter ranging from 0.1 mm to 0.4 mm, and is used for a monitor.

16. The cathode ray tube according to claim 14, wherein the deflection coil has a diameter ranging from 0.2 mm to 0.7 mm, and is used for a TV.

17. The cathode ray tube according to claim 6, wherein the aluminum layer has a cylindrical shape.

18. The cathode ray tube according to claim 6, wherein the deflection yoke comprises at least one of a rotation coil, a degaussing coil, a cancel coil, a CY coil, a CF coil, and a fetch line.

19. The cathode ray tube according to claim 6, wherein the deflection yoke further comprises a holder for insulating the horizontal and vertical deflection coils.

20. A conductive coil wire, comprising:
a conductive aluminum core;
an insulating layer surrounding the conductive core; and
a bonding layer including an adhesive surrounding the insulating layer.

21. The conductive coil according to claim 20, further comprises a copper layer surrounding the conductive aluminum core.

22. The conductive coil according to claim 20, wherein the conductive coil has a diameter ranging from 0.1 mm to 0.7 mm.
